(19) United States
(12) Patent Application Publication
(10) Pub. No.: US 2025/0033967 A1
(43) Pub. Date: Jan. 30, 2025

(54) SYSTEMS AND METHODS FOR PRODUCING SULFURIC ACID OR LIQUEFIED SULFUR DIOXIDE

(71) Applicant: CHEMETICS INC., Vancouver (CA)

(72) Inventors: Rene DIJKSTRA, North Vancouver (CA); Dominika KIDON, Vancouver (CA)

(21) Appl. No.: 18/715,583

(22) PCT Filed: Nov. 8, 2022
(86) PCT No.: PCT/CA2022/051649

§ 371 Date: May 31, 2024

Related U.S. Application Data
(60) Provisional application No. 63/285,944, filed on Dec. 3, 2021.

(51) Int. Cl. C01B 17/80; C01B 17/54

(52) U.S. Cl. CPC C01B 17/806; C01B 17/54

(57) ABSTRACT

Improved systems and methods are disclosed for producing sulfuric acid or for producing liquefied sulfur dioxide. The systems comprise a reactor for the combustion of sulfur to sulfur dioxide, a reactor gases heat exchanger, and either a contact apparatus and absorption apparatus combination or an absorption subsystem and liquefaction apparatus combination for producing either sulfuric acid or liquid sulfur dioxide respectively. By appropriately incorporating two recycle circuits, the first after the reactor gases heat exchanger and the second after the absorption apparatus or liquefaction apparatus, several advantages can be obtained. These include reductions in equipment size, complexity, power consumption energy losses, and suppression of NOx.

### TECHNICAL FIELD

The present invention pertains to improved systems and methods for producing SO₂, SO₃ and H₂SO₄ therefrom. The invention also pertains to similarly improved systems and methods for producing liquefied SO₂.

### BACKGROUND

Sulfur dioxide is a commonly produced industrial chemical for use as a reactant in various other chemical processes. It is produced in both pure SO₂ gas and/or liquefied SO₂form for sale and as a gas mixture for use in downstream processes. A major industrial application for sulfur dioxide is in the production of sulfuric acid which is one of the most produced commodity chemicals in the world and is widely used in the chemical industry and commercial products.

Nowadays, the contact process is the primary process used to produce sulfuric acid commercially (developed in 1831 by P. Phillips). Typically, this involves obtaining a supply of sulfur dioxide by combusting a supply of sulfur with ambient air and then oxidizing the sulfur dioxide with oxygen in the presence of a catalyst (typically vanadium oxide) to accelerate the reaction in order to produce sulfur trioxide. The reaction of sulfur dioxide to sulfur trioxide is reversible and exothermic and it is important to appropriately control the temperature of the gases over the catalyst in order to achieve the desired conversion without damaging the catalyst and/or the contact apparatus which comprises the catalyst.

The produced sulfur trioxide is then converted to sulfuric acid by absorption into a concentrated sulfuric acid solution with subsequent water addition to the now more concentrated acid to maintain the acid concentration. This indirect reaction of the sulfur trioxide with water avoids the consequences of directly dissolving sulfur trioxide into water which is a highly exothermic reaction. The absorbing of the sulfur trioxide is usually done in one or more absorption towers.

Distributors are used in the absorption towers to distribute strong sulfuric acid solution across the top of a packed bed within the tower. Sulfur trioxide gas flows through the tower in generally counter-current flow to the solution, but it can also flow cocurrently. The strong sulfuric acid solution is used to absorb the flowing sulfur trioxide. In CA2802885, an improved energy efficient system was disclosed for producing sulfuric acid that employs an intermediate absorption subsystem comprising a spray tower, an energy recovery subsystem, and an intermediate absorption tower comprising a packed bed. This and similar systems are commercially available under the trade-mark ALPHA™.

In WO2008/052649, a process was disclosed for the continuous catalytic complete or partial oxidation of a starting gas containing from 0.1 to 66% by volume of sulfur dioxide plus oxygen, in which the catalyst is kept active by means of pseudoisothermal process conditions with introduction or removal of energy. The related apparatus is for the continuous catalytic complete or partial oxidation of a starting gas containing sulfur dioxide and oxygen, and is characterized by at least one tube contact apparatus which is an upright heat exchanger composed of at least one double-walled tube whose catalyst-filled inner tube forms a reaction tube, with heat being transferred cocurrently around the reaction tube and an absorber for separating off SO₃ being installed downstream of the tube contact apparatus. The reactivity of the catalyst is preset by mixing with inert material. This process and apparatus are commercially available under the trade-marks CORE™ and CORE-S™.

U.S. Pat. No. 4,578,262 describes a method for the production of sulfur dioxide from a source of concentrated sulfur dioxide gas using a liquefaction system in which the tail gas from the liquefaction is returned to the sulfur combustion furnace. The sulfur combustion furnace is operated with ambient air.

In U.S. Pat. No. 3,803,298. a method for production of high purity sulfur dioxide with oxygen is described in which the sulfur reacts with oxygen in a plurality of combustion stages with cooling in between the combustion chambers at temperatures of 1700-2000° C. The resulting high purity sulfur dioxide is liquefied by cooling the gas below the sulfur dioxide boiling point.

Both U.S. Pat. No. 7,052,670 and U.S. Pat. No. 6,875,413 describe methods for the production of high purity sulfur dioxide by combustion of liquid sulfur with oxygen in a furnace. The furnace temperature is controlled by a recycle of SO₂ gas after cooling and passing through an absorber for the sulfur trioxide removal. High purity SO₂ product is obtained via liquefaction carried out on a portion of the gas after sulfur trioxide removal. The tail gas from the liquefaction unit is also recycled to the furnace.

Historically, commercial sulfur burning, sulfuric acid plants have used ambient air as the source of the oxygen required in the process. The use of ambient air is inexpensive and the conventional process operating at approximately 11-12 vol % SO₂ into the contact apparatus perfectly balances the O₂:SO₂ ratio required for high conversion and the maximum allowable temperature in the first catalyst bed. The disadvantage of using air is that each required molecule of oxygen also comes with approximately four molecules of inert gas (mainly N₂ and argon) which must also flow through the plant, therefore requiring very large equipment to handle the entire gas flow. To improve efficiencies and reduce emissions, commercial sulfuric acid plants using ambient air are often of the double contact, double absorption (DCDA) design. In a DCDA system, process gases are subjected to two contact and absorption stages in series, (i.e. a first catalytic conversion and subsequent absorption step followed by a second catalytic conversion and absorption step). Sulfur dioxide for the system can be produced by combusting sulfur with ambient air in a single reactor after which the reactor gases produced are cooled in a heat exchanger prior to being supplied to the contact apparatus. Details regarding the conventional options available and preferences for sulfuric acid production and the contact process are well known and can be found for instance in “Handbook of Sulfuric Acid Manufacturing”, Douglas Louie, ISBN 0-9738992-0-4, 2005, published by DKL Engineering, Inc., Ontario, Canada.

In an alternative approach, a staged combustion process may be employed to produce gases with a high sulfur dioxide concentration while minimizing the formation of nitrogen oxides (NOx) in the reactor. For instance, a two stage combustion process using ambient air may be employed in which a first combustion stage is performed below 1200° C. to keep NOx formation relatively low followed by a second combustion stage at higher temperature to produce gases with a relatively high sulfur dioxide concentration. The higher gas temperature desirably allows for a reduction in heat exchanger size. The staged combustion process is described for instance in U.S. Pat. No. 8,043,597.

The use of oxygen instead of air has long been considered to combust sulfur to sulfur dioxide as the use of oxygen can allow for a reduction in size for much of the equipment in the system in principle. However, the combustion process results in exceedingly high flame and reactor temperatures temperatures (>3900° C.) in a single reactor system. Such temperatures are much too high for the typical materials used for reactor construction and instead very expensive construction materials would be required. Further, substantial NOx formation occurs at such temperatures even from the little nitrogen that is typically present in “almost pure” oxygen (typically >0.2 vol % minimum). The NOx produced is a problem in the downstream process when the combustion product is used for either production of sulfuric acid or liquid sulfur dioxide.

The use of oxygen to-date has also been hindered by the cost of providing such oxygen and plants would have to offset the cost of oxygen against cost savings in the process. New and emerging technologies are now becoming available where oxygen or high purity oxygen is a by-product from the process (e.g., water hydrolysis to produce green hydrogen) and this can provide lower cost sources of oxygen with the potential for economic integration of various processes. One such example is described in published PCT application WO2021/118599 (application number PCT/US2019/066262).

A practical approach then for combusting sulfur with pure or almost pure oxygen then was to employ a staged combustion process in which heat removal between stages was used in order to reduce the temperatures in the sulfur reactors. Such an approach is described in EP2330075, EP2507164 and/or EP2507167. However, multiple combustion zones (reactors) and multiple heat exchangers are required and such a system is more expensive to build and more complicated to operate. Further, while the flame and reactor temperatures are kept below 2000° C. NOx formation is still likely despite these lower temperatures and nitrogen concentration.

In another approach for combusting sulfur with oxygen, reactor temperatures can be kept desirably low by recycling a portion of the gases following conversion in the contact apparatus (i.e. the flue gas). This approach is disclosed for instance in U.S. Pat. No. 4,046,866. Recycling this flue gas provides for an improved system design, but requires a very large recycle flow. Additionally, the concentration of nitrogen in the system is undesirably increased while the concentration of sulfur dioxide is undesirably decreased. Further, as the entire gas stream is cooled to a low temperature in the absorber, a significant amount of energy is no longer available to be recovered in the reactor heat exchanger. Further, such recycling requires an increase in the size of all the related equipment and power consumption for the significant recycling pump that is required. This recycling pump must overcome the pressure drop present in all the upstream equipment and requires more advanced designs. While the gas volume involved with this approach is lower than for conventional ambient air combustion, it is typically only about 30% smaller, thus eliminating much of the theoretical advantages of using oxygen.

In another approach for combusting sulfur with oxygen, reactor temperatures can be kept desirably low by recycling the reactor gases following cooling, sulfur trioxide absorption and sulfur dioxide liquefaction. This approach is disclosed for instance in U.S. Pat. No. 7,052,670. Recycling the gas in this manner provides for an improved system design, but as the gas is recycled after cooling and sulfur trioxide absorption, a substantial amount of energy is lost to the absorber liquid. Further, such recycling requires an increase in the size of all the related equipment and power consumption for the significant recycling pump that is required. This recycling pump must overcome the pressure drop present in all the upstream equipment and requires more advanced designs.

In a yet further approach then, a system comprising both staged combustion and a recycle of the flue gas has been considered. For instance, such a system may comprise two combustion stages in series, namely a first stage comprising a first reactor and heat exchanger followed by a second stage comprising a second reactor and heat exchanger. The gases obtained from the staged combustion are then supplied to a contact apparatus after which, and as above, a portion of the gases following conversion in the contact apparatus are recycled. Such an approach desirably reduces recycle flow, but there is still a relatively high nitrogen concentration in the reactors. While the flow involved is smaller and hence there is a smaller power and heat loss penalty, the system is more complicated and expensive than a single stage system.

Recently sulfuric acid plants and processes have been proposed in which sulfur combustion is carried out using pure oxygen and a submerged combustion process. In this process, oxygen is injected into a bath of molten sulfur. Energy released as the oxygen reacts with sulfur is used to evaporate sulfur from the bath. The sulfur evaporated is condensed in a downstream condenser to recover the energy and the condensed sulfur is returned to the bath. The advantage of submerged combustion is that the temperature of the combustion products are limited to the boiling point of sulfur which is ˜450° C. at pressure of 0.5 barg. This technology is disclosed in detail in Canadian patent application CA3021202 titled Sulfuric Acid Plant and published Dec. 24, 2018. The design offers lower capital expenditure as well as enhanced energy recovery and allows for practical production capacities in excess of 10,000 mtpd. The submerged combustion does not require a large gas recycle in order to control temperature. And minimal NOx formation is involved due to the low operating temperature. However, a submerged combustion system is relatively complex since it involves containment of sulfur vapor at high temperature and thus material concerns.

There remains a desire for continual improvement in plant design and operation for the production of sulfur dioxide, and particularly for the efficient and cost-effective production of ever larger volumes of sulfuric acid therefrom. The present invention addresses this desire and provides other benefits as disclosed below.

### SUMMARY

Improved systems and related methods have been developed for producing sulfuric acid and liquefied sulfur dioxide. The improvements include reductions in equipment size and/or equipment complexity, reductions in power consumption, improved energy efficiency, and in suppression of nitrogen oxide (NOx) formation when compared to options in the prior art. The improvements involve recycling both a portion of the combustion gas obtained from combusting sulfur to sulfur dioxide and also a portion of the gases obtained following the conversion of sulfur dioxide to either sulfuric acid or to sulfur dioxide liquid in the case of sulfuric acid and liquefied sulfur dioxide production respectively.

With this approach, the reactor used for the combustion of sulfur can be operated at any desired temperature, e.g. a modest temperature in a range around 1200-1400° C. such that NOx formation is suppressed, while also avoiding the formation of SO₃ which can lead to corrosion issues in other equipment.

Specifically, one embodiment of the invention is a system for the production of sulfuric acid comprising a reactor for the combustion of sulfur to sulfur dioxide, a reactor gases heat exchanger for cooling reactor outlet gases, a contact apparatus for the conversion of sulfur dioxide to sulfur trioxide, an absorption apparatus for absorbing sulfur trioxide into sulfuric acid to form more concentrated sulfuric acid, a first recycle circuit, and a second recycle circuit. The reactor comprises an inlet for a supply of sulfur, an inlet for a supply of oxygen at ≥90% purity by volume, a recycle inlet for recycle gases, and an outlet for reactor outlet gases comprising sulfur dioxide. The reactor gases heat exchanger comprises an inlet fluidly connected to the reactor outlet and an outlet for cooled reactor outlet gases. The contact apparatus comprises an inlet connected to the reactor gases heat exchanger outlet and an outlet for contact apparatus gases. The absorption apparatus comprises an inlet fluidly connected to the contact apparatus outlet, an outlet for the more concentrated sulfuric acid, and an outlet for unabsorbed contact apparatus gases. The first recycle circuit of the two recycle circuits comprises a first pump and fluidly connects the reactor gases heat exchanger outlet to the recycle inlet of the reactor, while the second recycle circuit comprises a second pump and fluidly connects the outlet of the absorption apparatus for unabsorbed contact apparatus gases to the recycle inlet of the reactor.

In this simplified embodiment, the reactor may consist of a single stage and may be the only reactor for the combustion of sulfur to sulfur dioxide in the system. Further, the system may be absent any submerged combustion reactor. Further still, the reactor gases heat exchanger may be the only reactor gases heat exchanger for cooling reactor outlet gases in the system.

The first and second pumps employed in the two recycle circuits can be selected from the typical group consisting of fans, blowers, ejectors and other types known to those in the art. The first recycle circuit can also comprise a recycle heat exchanger that, in a preferred embodiment, is located before the first pump in the first recycle circuit.

The invention, and in particular the above embodiment, is advantageous for application in a sulfuric acid plant, and allows for a single contact, single absorption plant design. Such a plant would comprise the aforementioned sulfur trioxide production system and at least one absorption system for converting sulfur trioxide to sulfuric acid. The absorption system would comprise an inlet connected to the contact apparatus outlet and an outlet for sulfuric acid.

Another embodiment of the invention is a system for the production of sulfur dioxide liquid comprising a reactor for the combustion of sulfur to sulfur dioxide, a reactor gases heat exchanger for cooling reactor outlet gases, an absorption subsystem comprising an absorption apparatus for the removal of sulfur trioxide by absorption into sulfuric acid to form more concentrated sulfuric acid, a liquefaction apparatus for the conversion of sulfur dioxide gas to sulfur dioxide liquid, a first recycle circuit, and a second recycle circuit. In a like manner to the previous embodiment, the reactor comprises an inlet for a supply of sulfur, an inlet for a supply of oxygen at ≥90% purity by volume, a recycle inlet for recycle gases, and an outlet for reactor outlet gases comprising sulfur dioxide. The reactor gases heat exchanger comprises an inlet fluidly connected to the reactor outlet and an outlet for cooled reactor outlet gases. In this embodiment however the absorption subsystem comprises an inlet fluidly connected to the reactor gases heat exchanger outlet, an outlet for unabsorbed reactor outlet gases, and an outlet for the concentrated sulfuric acid. Further, the liquefaction apparatus comprises an inlet connected to the absorption subsystem outlet, an outlet for unliquefied liquefaction apparatus gases, and an outlet for liquid sulfur dioxide. The first recycle circuit of the two recycle circuits again comprises a first pump and fluidly connects the reactor gases heat exchanger outlet to the recycle inlet of the reactor. Here, the second recycle circuit comprises a second pump and fluidly connects the outlet of the liquefaction apparatus for liquefaction apparatus gases to the recycle inlet of the reactor.

Related methods of the invention include methods for producing sulfuric acid in a sulfuric acid plant, and for producing sulfur dioxide liquid. In the first instance, the method comprises obtaining the aforementioned system for producing sulfuric acid and then the steps of supplying sulfur and oxygen at ≥90% purity to the sulfur inlet and the oxygen inlet of the reactor respectively, reacting the sulfur and oxygen in the reactor thereby producing reactor outlet gases comprising sulfur dioxide, directing the reactor outlet gases from the reactor outlet to the reactor gases heat exchanger inlet, cooling the reactor outlet gases in the reactor gases heat exchanger thereby producing cooled reactor outlet gases, directing a contact apparatus portion of the cooled reactor outlet gases to the contact apparatus inlet, pumping a recycle portion of the cooled reactor outlet gases to the recycle inlet of the reactor using the first pump in the first recycle circuit, converting sulfur dioxide in the contact apparatus portion of the cooled reactor outlet gases in the contact apparatus thereby producing contact apparatus gases comprising sulfur trioxide, directing the contact apparatus gases from the contact apparatus outlet to the absorption apparatus inlet, absorbing sulfur trioxide from the contact apparatus gases into sulfuric acid to form more concentrated sulfuric acid, and pumping a recycle portion of the unabsorbed contact apparatus gases to the recycle inlet of the reactor using the second pump in the second recycle circuit.

An advantage of the inventive method for producing sulfur trioxide is that the flow through the contact apparatus and subsequent equipment downstream (e.g. in a sulfuric acid plant) can be markedly reduced thereby reducing the size and cost of the associated equipment. For instance in a representative embodiment, the ratio of moles of gases in the contact apparatus portion of the reactor outlet gases to the total moles of gases in the reactor outlet gases may be less than 0.5. Further, the required flow of recycled contact apparatus gases is relatively low (i.e. the flow in the second recycle circuit) and thus the significant amount of equipment between the reactor gases heat exchanger and the second recycle pump can now be made much smaller. As a result of the reduced flow of contact apparatus gases, the amount of energy lost from the gas to the absorber liquid in the absorption subsystem or apparatus is reduced. In addition, the second recycle pump which needs to generate a relatively large pressure rise (and hence has a large power consumption) can be much smaller as well. For instance in a representative embodiment, the ratio of moles of gases in the recycled unabsorbed contact apparatus gases to the moles of gases in the reactor outlet gases is less than 0.2.

The present invention is also advantageous in that the reactor outlet gases comprise a relatively low concentration of nitrogen and a relatively high concentration of sulfur dioxide. In representative embodiments, the concentration of inert gases (predominantly nitrogen and argon) in the reactor outlet gases can be less than 30 mole %, while the concentration of sulfur dioxide in the reactor outlet gases can be greater than 30 mole %. Further, the ratio of moles of oxygen to moles of sulfur dioxide in the reactor outlet gases can be less than 0.65. And as mentioned above, the reactor can be operated at a modest temperature to suppress NOx formation, e.g. at a temperature less than 1500° C.

In a preferred embodiment of the invention, the first recycle circuit in the system comprises a recycle heat exchanger and the method comprises further cooling the recycle portion of the cooled reactor outlet gases in the first recycle circuit in the recycle heat exchanger.

As mentioned, the invention also includes methods for producing sulfuric acid in a sulfuric acid plant and for producing sulfur dioxide liquid. In the former, the method comprises producing sulfur trioxide according to the aforementioned steps, directing the contact apparatus gases comprising sulfur trioxide from the contact apparatus to at least one absorption apparatus, and then absorbing the sulfur trioxide in the contact apparatus gases using the absorption apparatus thereby producing sulfuric acid. In the latter, the method comprises obtaining the aforementioned system for producing sulfur dioxide liquid, supplying sulfur and oxygen at ≥90% purity to the sulfur inlet and the oxygen inlet of the reactor respectively, reacting the sulfur and oxygen in the reactor thereby producing reactor outlet gases comprising sulfur dioxide, directing the reactor outlet gases from the reactor outlet to the reactor gases heat exchanger inlet, cooling the reactor outlet gases in the reactor gases heat exchanger thereby producing cooled reactor outlet gases, directing a liquefaction apparatus portion of the cooled reactor outlet gases to the absorption subsystem inlet, pumping a recycle portion of the cooled reactor outlet gases to the recycle inlet of the reactor using the first pump in the first recycle circuit, absorbing sulfur trioxide from the liquefaction apparatus portion of the cooled reactor outlet gases into sulfuric acid to form more concentrated sulfuric acid and unabsorbed reactor outlet gases comprising sulfur dioxide,

directing the unabsorbed reactor outlet gases to the liquefaction apparatus inlet, liquefying sulfur dioxide in the unabsorbed reactor outlet gases to produce liquid sulfur dioxide and liquefaction apparatus gases, and pumping a recycle portion of the liquefaction apparatus gases to the recycle inlet of the reactor using the second pump in the second recycle circuit.

### BRIEF DESCRIPTION OF THE DRAWINGS

FIG. 1a is a schematic of a portion of the conventional DCDA (double contact, double absorption) sulfuric acid plant of the prior art which uses ambient air in the sulfur combustion.

FIG. 1b is a schematic of a high concentration sulfuric acid plant of the prior art which uses ambient air and two stages of sulfur combustion.

FIG. 1c is a schematic of a conceptual sulfuric acid plant based on using the plant shown in FIG. 1a but using pure oxygen in the sulfur combustion.

FIG. 1d is a schematic of a sulfuric acid plant which uses staged combustion with three stages and pure oxygen in the sulfur combustion.

FIG. 1e is a schematic of a sulfuric acid plant of the prior art which uses pure oxygen in the sulfur combustion and recycles a substantial amount of flue gas after the absorption step.

FIG. 1f is a schematic of a sulfuric acid plant which uses submerged combustion and pure oxygen in the sulfur combustion and which recycles a modest amount of flue gas after the absorption step.

FIG. 1g is a schematic of a sulfuric acid plant which uses staged combustion with two stages and pure oxygen in the sulfur combustion and which additionally recycles flue gas after the absorption step.

FIG. 2a is a schematic of a sulfuric acid plant of the invention which uses pure oxygen in the sulfur combustion and recycles both a portion of the cooled reactor gases after the reacting and heat exchanging steps and a portion of unabsorbed contact apparatus gases after the absorption step.

FIG. 2b is a schematic of a preferred sulfuric acid plant of the invention which is similar to that of FIG. 2a but which additionally employs a recycle heat exchanger in the first recycle circuit to further cool the recycling cooled reactor outlet gases.

FIG. 3 is a schematic of a conventional system for producing liquid sulfur dioxide according to the prior art.

FIG. 4 is a schematic of a system of the invention for producing liquid sulfur dioxide.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

The words “oxygen” or “pure oxygen” are to be considered as meaning oxygen in concentrations equal to or exceeding 90% by volume.

The trade-mark CORE-S™ refers to the molten salt cooled tubular reactor of the technology disclosed in the aforementioned WO2008/052649.

The present invention provides improved systems and methods for producing sulfuric acid and/or liquefied sulfur dioxide. Compared with conventional options in the art, reductions in equipment size and/or equipment complexity, reductions in power consumption, and in suppression of nitrogen oxide (NOx) can be obtained. For instance, a system of the invention for producing sulfuric acid is easier to operate and of lower complexity and cost than systems employing submerged combustion or staged combustion. Due to the higher combustion temperature involved, the heat exchanger employed can be made smaller than that in a conventional DCDA sulfuric acid plant. However the temperature can be kept low enough to suppress the formation of NOx.

To obtain these benefits, appropriate portions of gases are recycled back to the sulfur combustion reactor from two different points further downstream in the system. In a first recycle, an appropriate portion of the combustion gas obtained from combusting sulfur to sulfur dioxide is recycled. In a second recycle, an appropriate portion of the gases obtained following the conversion of sulfur dioxide to either sulfuric acid or to sulfur dioxide liquid is recycled—in the case of sulfuric acid and liquefied sulfur dioxide production respectively.

With this relatively simple approach, high concentration sulfur dioxide gas can be produced at moderate temperatures. Power consumption can be minimized by cooling gas upstream of the hot gas recycling pumps. And because the combustion reactor is operated at a moderate temperature, NOx formation is suppressed.

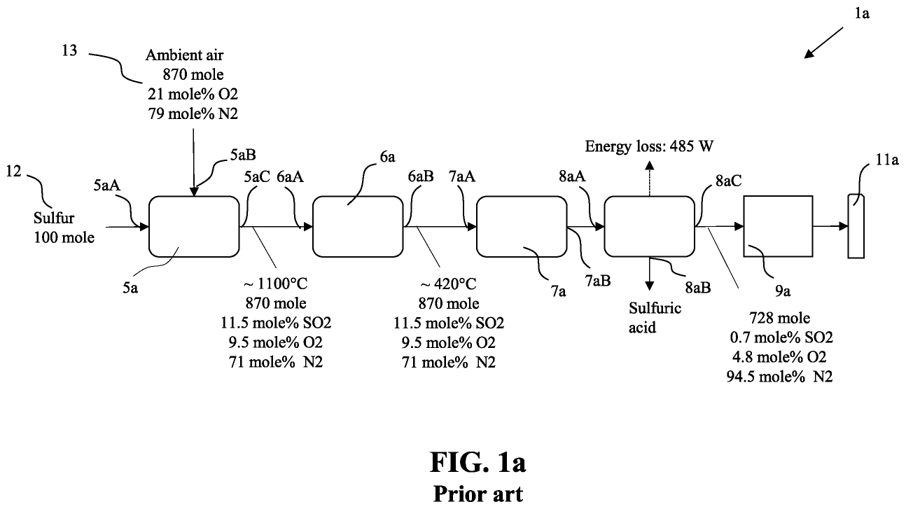

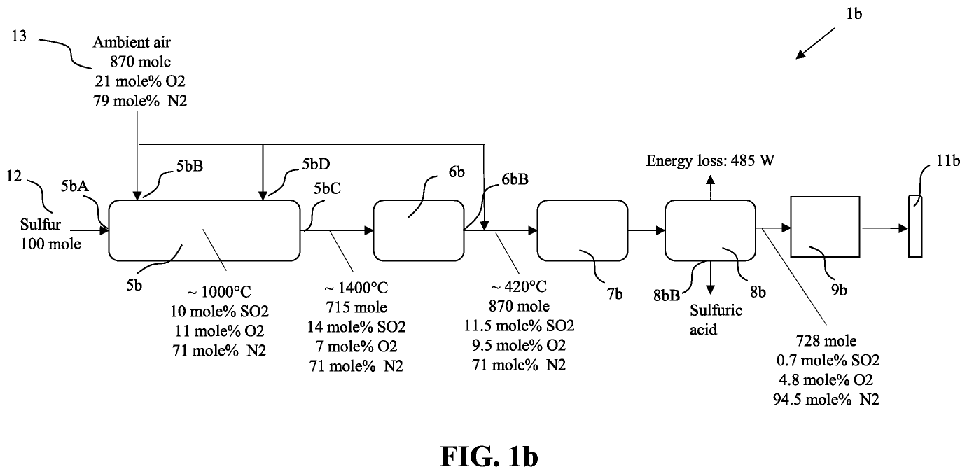

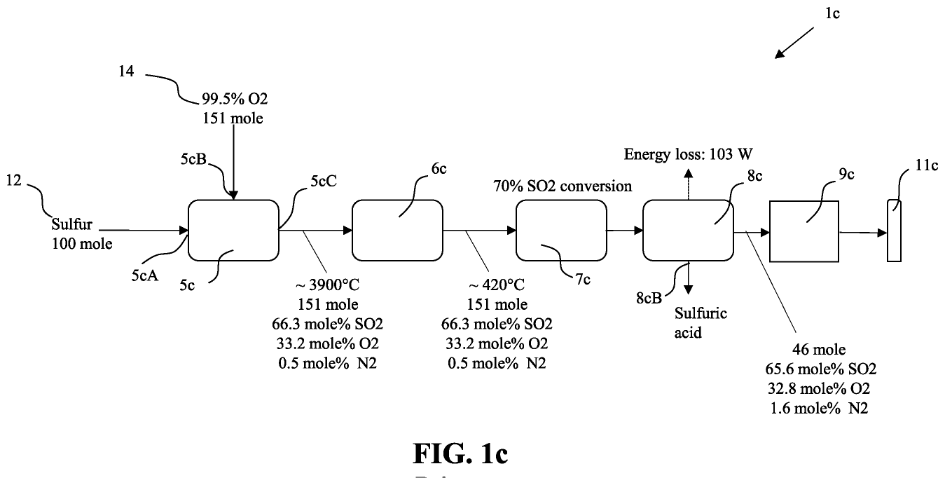

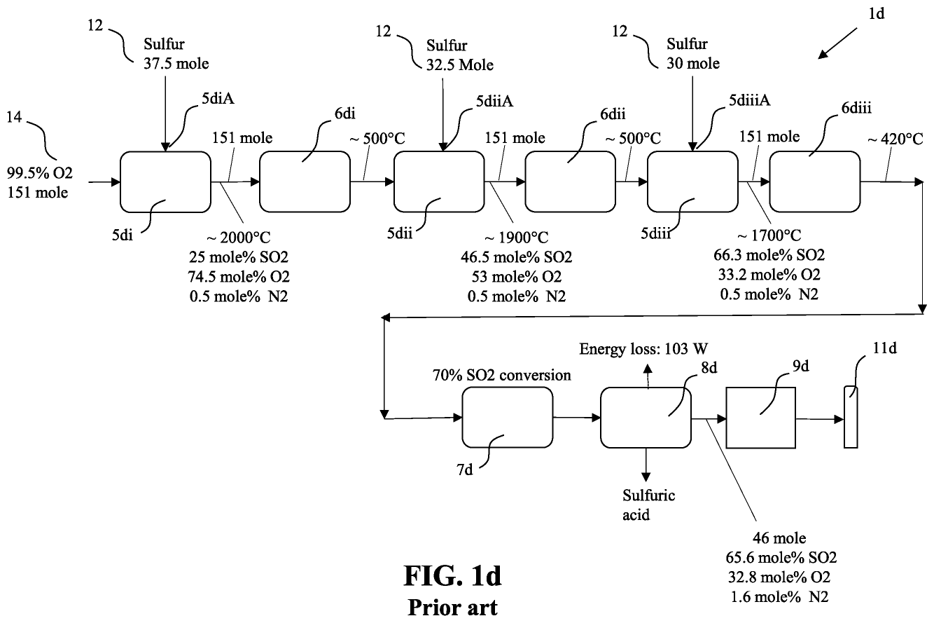

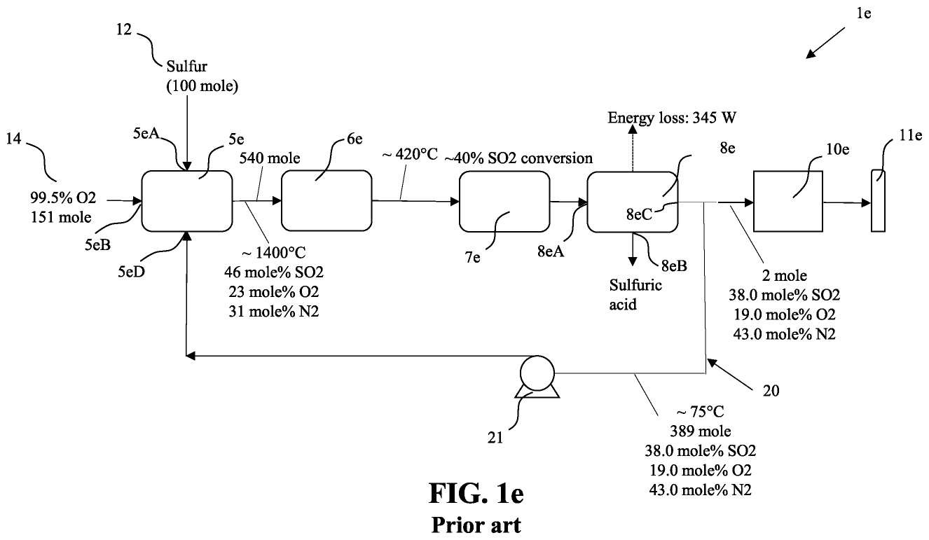

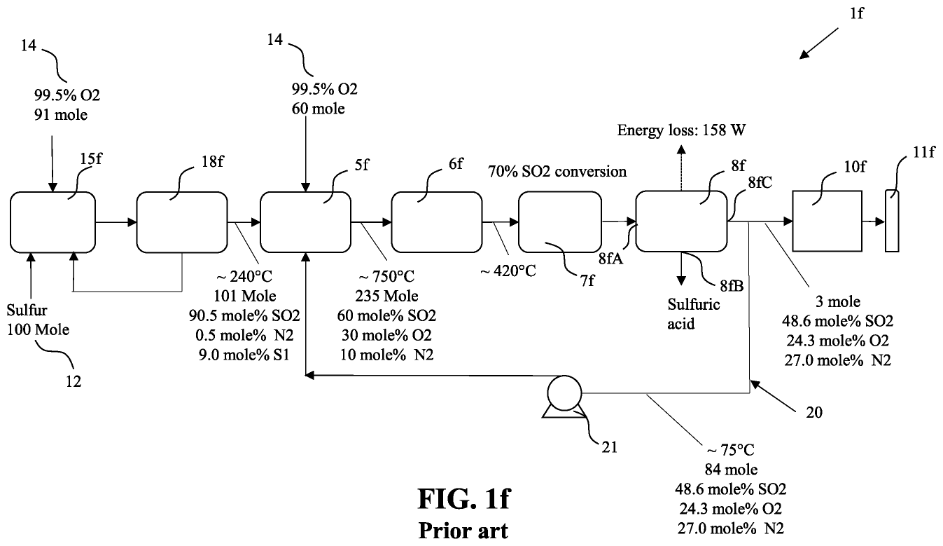

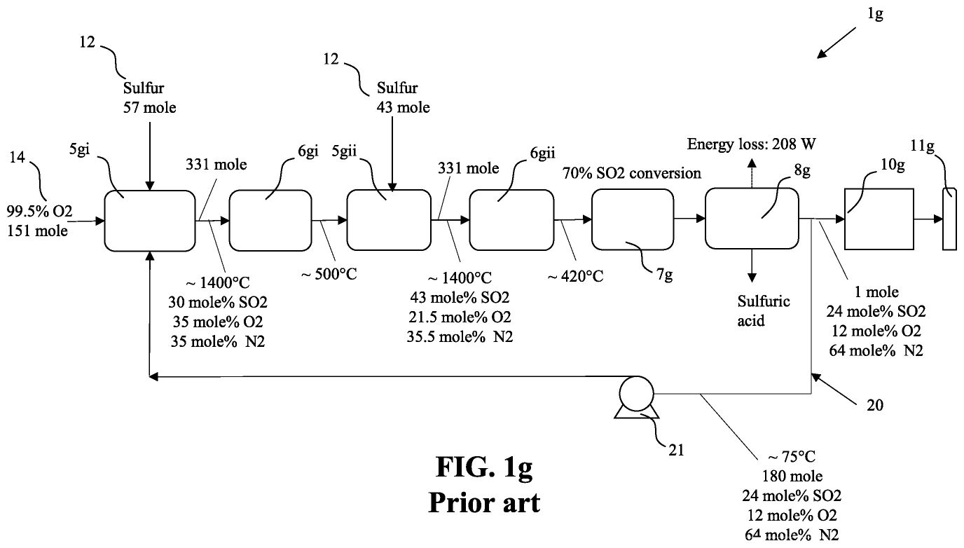

The differences in structure between numerous conventional systems of the prior art and the present invention can be seen by comparing the system schematics shown in the following figures. FIG. 1a for instance shows a schematic of a portion of a conventional DCDA (double contact, double absorption) sulfuric acid plant of the prior art which uses ambient air in the sulfur combustion. Here, DCDA sulfuric acid plant 1a comprises reactor 5a for combusting sulfur to sulfur dioxide, heat exchanger 6a for cooling outlet gases from reactor 5a, contact apparatus 7a for converting SO₂ to SO₃, and absorption apparatus 8a for absorbing SO₃ into a supply of sulfuric acid at lower concentration. Downstream of absorption apparatus 8a is additional equipment 9a for additional required process steps as is well known to those in the art, followed by stack 11a for exhausting gases from the system. Note that to avoid clutter in this and subsequent figures, only a single contact stage and a single absorption stage are shown. That is, the second contact stage and the second absorption stage and additional apparatuses and interconnecting lines involved for a double contact, double absorption sulfuric acid plant are instead represented by single element 9a in order to avoid clutter and complication not directly relevant to the improvements of the present invention. Those skilled in the art also readily appreciate that contact apparatus 7a and absorption apparatus 8a typically involve more physical elements and more interconnections than are shown in the simplified schematics here. Further, additional equipment 9a is shown as a single element in this and subsequent figures, but here too the apparatuses and interconnecting lines involved include more elements in more complex arrangements. Note also that throughout the figures, elements that share a common functionality are denoted with the same initial identifying numeral. But because such elements can differ in size, number of inlets and/or outlet ports, etc., they may be denoted with different subsequent identifying indicae (e.g. reactor 5a, 5b, 5c and so on).

In sulfuric acid plant 1a, sulfur 12 and ambient air 13 are supplied to reactor 5a at inlets 5aA and 5aB respectively and are reacted together to form SO₂. Reactor outlet gases containing this SO₂ are obtained from reactor 5a at outlet 5aC and are directed to inlet 6aA of heat exchanger 6a in which these gases are cooled. The cooled reactor gases are then directed from heat exchanger outlet 6aB to contact apparatus 7a at inlet 7aA. In contact apparatus 7a, SO₂ in the cooled reactor gases is converted to SO₃ after which the gases from contact apparatus 7a are directed from outlet 7aB to absorption apparatus 8a at inlet 8aA. In absorption apparatus 8a, SO₃ is absorbed into a weaker sulfuric acid solution to produce the desired, higher concentration sulfuric acid product. This higher concentration sulfuric acid is removed at outlet 8aB and the remaining unabsorbed gases from the contact apparatus are removed at outlet 8aC and then directed to additional equipment 9a to be subsequently processed in a conventional manner.

FIG. 1b shows a schematic of another type of conventional DCDA in the prior art which is disclosed for instance in U.S. Pat. No. 8,043,597. Here, DCDA sulfuric acid plant 1b uses ambient air but involves two stages of sulfur combustion within a common reactor. The schematic in FIG. 1b is similar to that of FIG. 1a except that reactor 5b is designed to provide two combustion stages (e.g. a first combustion at lower temperature, followed by a second combustion at higher temperature) and comprises two inlets 5bB, 5bD for ambient air 13 for this purpose. Further, heat exchanger 6b typically differs in that a somewhat different volume of reactor outlet gases at a somewhat different temperature is involved. Sulfuric acid plant 1b is advantageous in that the use of staged combustion can reduce NOx formation in reactor 5b and yet the higher gas temperature of the second stage allows for a reduction in the size of heat exchanger 6b.

Another approach contemplated in the prior art is illustrated in the schematic of FIG. 1c. Here, conceptual sulfuric acid plant 1c is shown based on using the plant shown in FIG. 1a (i.e. a single reactor) but (almost) pure oxygen 12 instead of ambient air in the sulfur combustion. In principle, very high concentrations of SO₂ can desirably be produced and the volumes of process gases to be dealt with—and hence the size of all the equipment downstream of the reactor—can be markedly reduced accordingly. However, plant 1c is impractical because reactor 5c would be operating at exceedingly high temperatures (around 3900° C.) and industrial reactors capable of this are not commercially feasible. Further, a heat exchanger 6c capable of handling reactor outlet gases at such exceedingly high temperatures would also be required. Further still, the formation of a substantial amount of NOx cannot be avoided at such exceedingly high temperatures even from the little nitrogen that is typically present in “almost pure” oxygen. [In this and other embodiments described herein, pure oxygen may be obtained in various ways known to those in the art, e.g. vacuum pressure swing adsorption (VPSA) and cryogenic air separation processes are commonly known. When using a VPSA process, the oxygen enrichment is typically limited to about 93% oxygen maximum, whereas cryogenic air separation is typically used to produce oxygen at greater than 95% concentration. For these processes the relative nitrogen content decreases and the argon content increases when the oxygen concentration is increased. For example; at 93% oxygen (VPSA process), there is approximately 3% nitrogen and 4% argon present, at 95% oxygen (cryogenic process) the remainder is approximately 1.2% nitrogen and 3.8% argon and at 99.5% oxygen or higher, the remainder is almost entirely argon with only ppm levels of nitrogen.]

FIG. 1d illustrates yet another conventional approach in the prior art in which staged combustion is employed with a heat exchange step employed after each combustion stage. Here, DCDA sulfuric acid plant 1d uses three stages in the staged combustion and pure oxygen in the sulfur combustion, but is otherwise similar to plant 1a shown in FIG. 1a. As shown then, plant 1d comprises three reactors 5di, 5dii, 5diii and three heat exchangers 6di, 6dii, 6diii located downstream of each reactor respectively. Sulfur 12 is supplied to each reactor 5di, 5dii, 5diii at inlets 5diA, 5diiA, 5diiiA respectively while pure oxygen 14 is supplied only to the first stage reactor 5di at inlet 5diB. The advantage of this arrangement is that pure oxygen can be used instead of ambient air, with the associated benefits from reduced gas volumes and nitrogen concentration. By providing heat removal between stages, the temperatures in the combustion stages are reduced. Still, some NOx formation is likely as a result of the high temperatures in each reactor. The biggest disadvantage is that multiple reactors and heat exchangers are required and plant 1d is more complex and expensive to build and more complicated to operate.

In a yet other approach disclosed for instance in U.S. Pat. No. 4,046,866, pure oxygen can be used for combustion with the reactor temperatures being controlled with recycled flue gas. FIG. 1e illustrates this approach in which sulfuric acid plant 1e has a similar arrangement to that shown in FIG. 1a (namely comprising reactor 5e, heat exchanger 6e, contact apparatus 7e, and absorption apparatus 8e in the same configuration) but which also includes recycle circuit 20 that fluidly connects outlet 8eC of absorption apparatus 8e to recycle inlet 5eD of reactor 5e. Additional equipment 10e represents a tail gas treatment system to remove SO₂ from the small flow of gas leaving the recycle circuit before discharge to stack 11e instead of the second contact and second absorption apparatus of some of the previous examples. (Additional equipment 10e has been identified differently from additional equipment 9a, 9b, etc. in the previous figures because the entire gas flow no longer goes through all this equipment. Rather, only a small purge stream containing those inert gases coming in with the supplied pure oxygen does.) With this arrangement, cooler unabsorbed contact apparatus gases from absorption apparatus 8e can be pumped using pump 21 to reactor 5e to dilute and cool the combustion gases in reactor 5e. This approach represents an improvement but requires a very large recycle flow volume. While the recycled gases reduce the reactor temperature, it undesirably increases the nitrogen concentration and decreases the sulfur dioxide concentration in the reactor outlet gases. Further, the high recycle volume not only limits the conversion that can be achieved in the contact apparatus but also necessitates an increase in the size of all the plant equipment upstream of pump 21 and there is a significant power consumption associated with operation of pump 21 (both as a result of the volume involved and the significant pressure drop it must overcome which additionally requires more advanced designs for pump 21). The net result is that the gas volume involved is still lower than that in conventional plants using ambient air for combustion, but the volume is only ˜30% smaller thus eliminating much of the theoretical advantage of using pure oxygen.

Recently, another approach was disclosed in CA3021202 in which the improved sulfuric acid plant therein used submerged combustion and pure oxygen in the sulfur combustion and could also involve recycling a modest amount of flue gas after the absorption step. This arrangement is illustrated in the schematic of FIG. 1f. Here, the sulfur combustion process in sulfuric acid plant If involves a primary (submerged) combustion in submerged combustion reactor 15f followed by a secondary combustion in reactor 5f, which is functionally similar to reactor 5a in FIG. 1a. In the related process, the gas mixture comprising sulfur dioxide and sulfur vapour produced from the primary combustion is directed to sulfur condenser 18f in which sulfur vapour is condensed, removed, and returned to submerged combustion reactor 15f. The remaining uncondensed gas mixture comprising concentrated sulfur dioxide and residual sulfur vapour is directed to reactor 5f. As in the other illustrated embodiments using pure oxygen, sulfuric acid plant If uses supplies of sulfur 12 and pure oxygen 14 and remainder of the plant comprises heat exchanger 6f, contact apparatus 7f, absorption apparatus 8f and additional equipment 10f. Further sulfuric acid plant If includes recycle circuit 20 which is similar in design and function to that shown in FIG. 1e. The use of submerged combustion is advantageous in that a large gas recycle volume is not required to control combustion temperature. Further, there is minimal NOx formation due to the low operating temperature. The recycle is provided only to maximize conversion of sulfur dioxide and utilization of oxygen. The gas volume through the plant is desirably low and thus all the required equipment can be made significantly smaller. However, the illustrated submerged combustion based system is relatively complex since sulfur vapour at high temperature must be dealt with and there are associated material concerns. Further, like the recycle circuit in FIG. 1e, pump 21 must overcome the significant pressure drop from all the equipment in the plant line-up thereby requiring a more advanced design pump.

In yet another approach which may be considered based on conventional approaches in the prior art, FIG. 1g shows a schematic of sulfuric acid plant 1g which uses staged combustion with two stages and pure oxygen in the sulfur combustion and which additionally recycles flue gas after the absorption step. Thus plant 1g combines the staged combustion approach illustrated in FIG. 1d with the beneficial recycle of FIG. 1e. As shown, the two combustion stages occur sequentially in reactors 5gi and 5gii with cooling provided after each stage in heat exchangers 6gi and 6gii respectively. By using staged combustion, the recycle flow volume is reduced but a relatively high nitrogen concentration remains in the reactors. As with other embodiments employing a flue gas recycle, the size of all the equipment in the plant must be somewhat larger than that of a plant without recycle along with the power consumption associated with use of recycle pump 21. Compared with the single stage combustion embodiment of FIG. 1e, a smaller gas flow is involved however and hence there is a smaller power penalty. But the plant is more complicated and expensive. Compared with the submerged combustion embodiment of FIG. 1f, a larger gas flow is involved but the system is slightly less complicated.

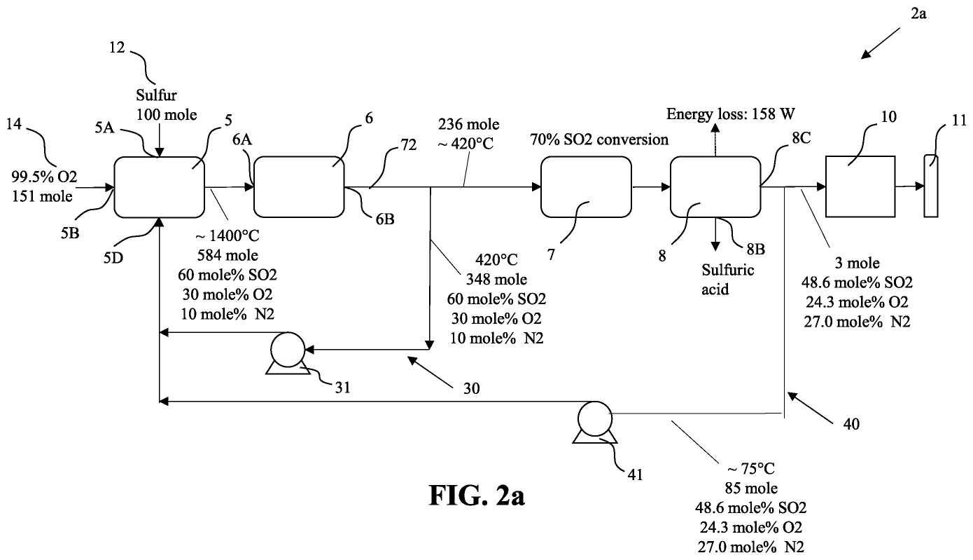

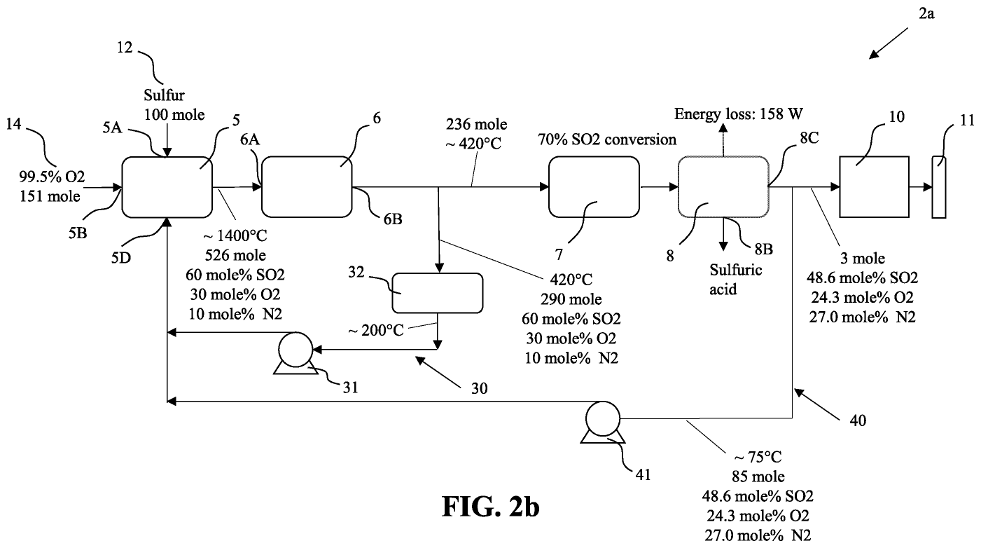

A sulfuric acid plant of the present invention however can be very similar to the embodiment shown in FIG. 1e except that a second recycle circuit is included which serves to recycle a portion of the reactor outlet gases back to the reactor. Reactor temperature and NOx formation is reduced with minimal additional equipment and complexity. FIG. 2a shows a schematic of an inventive sulfuric acid plant 2a which, like previous embodiments, comprises reactor 5, reactor gases heat exchanger 6, contact apparatus 7, absorption apparatus 8 and additional equipment 10. Sulfur 12 and pure oxygen 14 are supplied to reactor inlets 5A and 5B respectively for combustion. Here however gases from both first recycle circuit 30 and second recycle circuit 40 are used to dilute and cool combustion gases in reactor 5. First recycle circuit 30 fluidly connects outlet 6B of reactor gases heat exchanger 6 to recycle inlet 5D of reactor 5 and thus recycles a portion of the cooled reactor gases from reactor gases heat exchanger 6, while second recycle circuit 40 also fluidly connects absorption apparatus outlet 8C to recycle inlet 5D of reactor 5 and thus recycles a portion of the unabsorbed contact apparatus gases from absorption apparatus 8.

The advantages of this approach are numerous. Using first recycle circuit 30 results in a reduction in gas volume throughout the plant and hence the equipment involved can be sized much smaller (e.g. similar to that of the submerged combustion based embodiment of FIG. 1f) and the power requirement for the recycle flue gas pump 41 in second recycle circuit 40 is reduced. Desirably, only a single combustion stage is used (i.e. a single reactor and heat exchanger). The arrangement additionally provides for significantly lower nitrogen and significantly higher sulfur dioxide concentrations thereby reducing the risk of NOx formation while allowing higher reactor operating temperatures and use of a smaller reactor gases heat exchanger. Further, the equipment downstream of reactor gases heat exchanger 6 in the plant can be made much smaller than that required in the plant of FIG. 1e and as a result of the reduced gas volume entering the absorption apparatus 8, more energy can be recovered in reactor gases heat exchanger 6. There is also only a small pressure drop that pump 31 in first recycle circuit 30 must overcome thereby resulting in a lower power consumption requirement for the overall recycle volume involved. Further still, the amount of flue gas recycle in second recycle circuit 40 no longer needs to be set based on the need to control the combustion reactor temperature. Those of ordinary skill will recognize that the amount of gas in recycle circuit 40 now only depends on the conversion of SO₂ to SO₃ in contact apparatus 7 and merely serves to recycle unconverted SO₂ and O₂ to reactor 5 for additional conversion to SO₃. Those of ordinary skill will further recognize that the temperature of reactor 5 can be adjusted by increasing or decreasing the amount of recycle gas in the first recycle circuit. Those of ordinary skill will further recognize that reactor gases heat exchanger 6 could consist of a single stage, such as a boiler, or multiple stages (e.g. a boiler and superheater combination) and may also require multiple units in parallel to accommodate large plant capacities.

In principle any type of pump may be considered for use as pumps 31 and 41 in the two recycle circuits, including blowers or fans (e.g. as per U.S. Pat. No. 4,552,747) or ejectors (e.g. as per U.S. Pat. No. 6,508,998 where in the instant case oxygen would be used as the active fluid). However, due to the larger pressure difference that pump 41 must deal with in second recycle circuit 40, pump 41 would likely need to be of more advanced design than pump 31 in first recycle circuit 30.

In system 2a, the temperature of reactor 5 and the size and outlet temperature of reactor gases heat exchanger 6 would be set as per teachings of prior art relating to the embodiment of FIG. 1e, but advantageously the operating temperature and design of contact apparatus 7 can now be optimized to maximize conversion of SO₂ to SO₃ without the need to ensure that sufficient flow in recycle circuit 20 is maintained to cool reactor 5e. Further, in the design and operation of inventive systems like that shown in FIG. 2a, those skilled in the art can obtain guidance from the information provided in the following Examples.

FIG. 2b shows a schematic of another and preferred embodiment of the invention. Here, inventive sulfuric acid plant 2b is essentially similar to that of FIG. 2a but additionally employs a recycle heat exchanger 32 in first recycle circuit 30 in order to further cool the recycling cooled reactor outlet gases. This additional cooling reduces the volume required in first recycle circuit 30 and hence in the size of pump 31i and associated power consumption, as well as the size of reactor 5 and reactor gases heat exchanger 6.

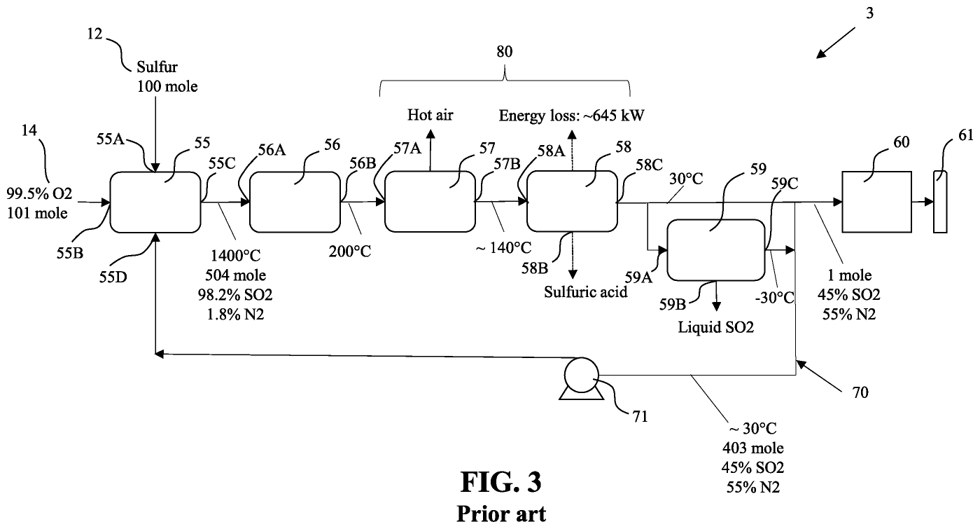

FIG. 3 shows a schematic of a conventional system for producing liquid sulfur dioxide according to the prior art as disclosed for instance in U.S. Pat. No. 7,052,670. Here, pure oxygen can again be used for combustion with the reactor temperatures being controlled with recycled flue gas. FIG. 3a illustrates this approach in which the sulfur dioxide liquid system has a similar arrangement to that shown in FIG. 1e. That is, liquid sulfur dioxide system 3 comprises reactor 55 for combusting sulfur to sulfur dioxide and reactor gases heat exchanger 56 for cooling outlet gases from reactor 55. Sulfur 12 and pure oxygen 14 are supplied to reactor 55 at inlets 55A and 55B respectively and are reacted together to form SO₂. Reactor outlet gases containing this SO₂ are obtained from reactor 55 at outlet 55C and are directed to inlet 56A of reactor gases heat exchanger 56 in which these gases are cooled. Next however, the cooled reactor gases are directed from outlet 56B to absorption subsystem 80 in which undesired sulfur trioxide present in the reactor gases is removed before the sulfur dioxide therein is liquefied in liquefaction apparatus 59. As shown in FIG. 3, absorption subsystem 80 comprises absorption apparatus 58 and an additional, optional absorption heat exchanger 57 in which the outlet gases of heat exchanger 56 are further cooled before entering absorption apparatus 58. As is well known in the art, additional cooling of the reactor gases in this manner is desirable in order to recover as much energy as possible before the absorption step. Note that the reactor gases are typically cooled to about 140° C. (but not lower due to the potential for acid condensation otherwise).

As shown in FIG. 3 then, the inlet for absorption subsystem 80 is thus inlet 57A of absorption heat exchanger 57. The reactor gases are further cooled and then directed from outlet 57B to inlet 58A of absorption apparatus 58. Undesired sulfur trioxide is then removed in a like manner to other absorption apparatus discussed above (i.e. sulfur trioxide is absorbed into weaker sulfuric acid to form more concentrated sulfuric acid which is removed at outlet 58B. A portion of the unabsorbed reactor outlet gases are then directed from outlet 58C to inlet 59A of liquefaction apparatus 59 in which sulfur dioxide is liquefied and removed as the desired product at outlet 59B. Additionally however, the other portion of the unabsorbed reactor outlet gases from outlet 58C are directly recycled back to reactor 55 at inlet 55D via recycle circuit 70. This other portion of gases being directly recycled to reactor 55 is used to control the reactor temperature. In addition, the remaining unliquefied gases from liquefaction apparatus 59 are directed out from outlet 59C whereupon they join this other portion of gases in recycle circuit 70 and are thus also recycled back to reactor 55. Again for simplicity and to reduce clutter, the additional equipment required for those additional required process steps known to those in the art are simply represented by additional equipment 60 in FIG. 3. Such additional equipment 60 for instance represents a tail gas treatment system to remove sulfur dioxide from the small flow of gas leaving the recycle circuit before discharge to a stack 61. With this arrangement, cooler gases from absorption apparatus 58 can be pumped using pump 71 to reactor 55 to dilute and cool the combustion gases therein. This approach requires a large recycle flow and necessitates an increase in the size of all the system equipment upstream of pump 71. Due to the low operating temperature of absorption apparatus 58, there is considerable loss of energy from cooling the entire gas stream.

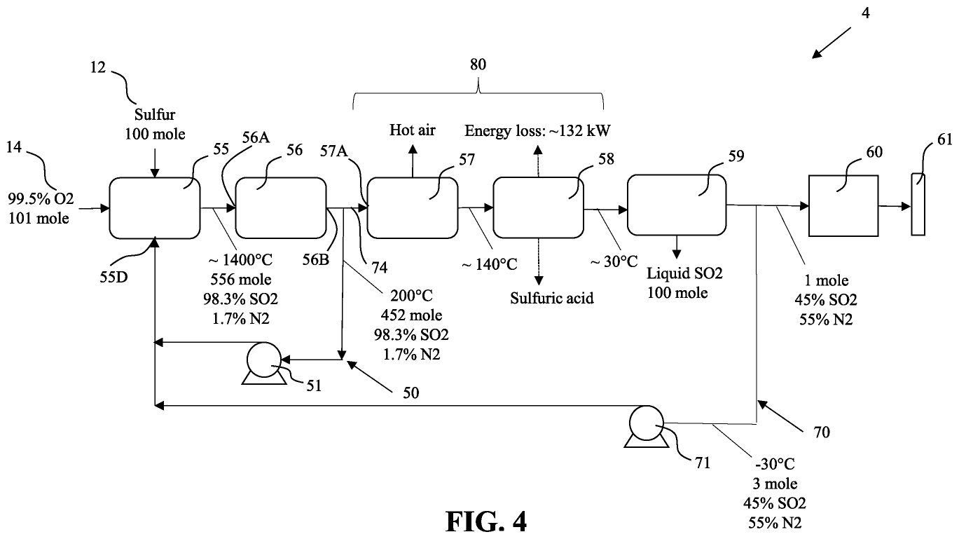

Next, FIG. 4 shows a schematic of a system for producing liquid sulfur dioxide according to the invention. System 4 here has a similar arrangement to that shown in FIG. 3, but instead now comprises two recycle circuits, namely first recycle circuit 50 comprising first pump 51 and second recycle circuit 70 comprising second pump 71. Second recycle circuit 70 has a similar configuration to that shown in FIG. 3. However, first recycle circuit 50, which is primarily used to cool reactor 55, is taken off directly from the outlet 56B from the reactor gases heat exchanger 56 and thus prior to entering absorption subsystem 80. In this way, only the portion of the reactor gases required for liquid sulfur dioxide production is directed to absorption subsystem 80 and liquefaction apparatus 59. This approach significantly reduces the gas flow that must be cooled prior to liquefying and the associated energy loss is reduced. [As those skilled in the art will appreciate, reactor gases heat exchanger 56 and absorption heat exchanger 57 could instead be a single unit exchanger. However, the embodiment shown is considered preferred. Functionally the former would be a “boiler” (i.e. producing steam) and the latter an “economizer” (i.e. producing hot boiler feed water). Further, the location of first recycle circuit might in principle be located downstream of absorption heat exchanger 57 but preferably it is located as shown between these two heat exchangers so that only reactor gases heat exchanger 56 has to be sized for the full gas flow.]

While the above description discloses the general arrangement and operation of certain embodiments of the invention, those of ordinary skill will appreciate that certain specifics may need to be modified somewhat in accordance with differing situations and plant apparatus. It is expected however that those of ordinary skill will readily be able to make such modifications based on the disclosed teachings and the following Examples for guidance.

Further, those skilled in the art will recognize that a simplified system using only the first recycle circuit in the sulfur combustion (represented by the set of elements 5, 6, 30 and 31 in FIG. 2b and 55, 56, 50 and 51 in FIG. 4) can still provide many of the benefits for applications that require a gaseous SO₂ product only (i.e. stream 72 or 74 being the SO₂ product in FIGS. 2a and 4 respectively), wherein the first recycle circuit is used to control the temperature in the reactor. In this case ambient air, oxygen enriched air or pure oxygen could all be used for the sulfur combustion depending on the desired SO2 product stream concentration. As an example, adding concentrated SO₂ gas to a standard DCDA plant may be considered to squeeze more production from an existing plant without a significant increase in the gas volume flowing through the existing plant equipment. There are also other applications where concentrated gaseous SO₂ is used (e.g. in mining) and liquid SO₂ is currently bought for this purpose and on-site SO₂ generation using the simplified system could provide operational benefits and/or cost savings. In theory, this simplified system can also be used where a higher SO₂ concentration is desired in a conventional DCDA plant which can then be accomplished by changing the oxygen source in the conventional plant from ambient air to oxygen enriched air.

The following Examples have been included to illustrate certain aspects of the invention but should not be construed as limiting in any way.

### Examples

Computer modeling was used to calculate and compare the expected flows and compositions in a variety of sulfuric acid plants of differing designs but with the same plant capacity for purposes of direct comparison. In this comparison, sulfuric acid plants based on each of the prior art designs shown in FIGS. 1a through 1f were included along with inventive sulfuric acid plants based on the designs shown in FIGS. 2a and 2b. For easy comparison, in each case it was assumed that 100 moles per hour of pure molten sulfur was used as a feedstock and combusted and that an appropriate stoichiometric amount of ambient air or pure oxygen was used in the combustion and conversion depending on the plant design.

In each case considered, the molten sulfur temperature was assumed to be 140° C. ambient air was assumed to be 75° C. and oxygen was assumed to be at 25° C. Further, in these illustrative computer modeled Examples, oxygen was assumed to be 99.5% pure oxygen with the remainder shown as nitrogen only for simplification of the inert species present. While such oxygen concentrations are typical of those obtained from a cryogenic air separation system, the remainder in such a case could almost entirely be argon and not nitrogen. Those of ordinary skill would of course be expected to readily be able to adjust these models according to the oxygen production unit employed and what species and concentrations are present. Conversion of SO₂ to SO₃ for cases with a gas recycle was limited to a maximum of 70% whereas a specific conversion rate for other cases was not used as the conversion value does not impact the results shown. This conversion was used to serve as a conservative comparison against the prior art and in no way implies that higher conversion is not contemplated for the inventive system. To calculate the energy lost from the hot gas as it is cooled in the absorption apparatus or subsystem, it was assumed that the absorption apparatus gas inlet temperature was 140° C.

The results of this computer modelling, namely gas compositions (shown in mole %) at various points in the gas stream, flow amounts (shown as number of moles of gas [rounded off]), and gas temperatures (shown in ° C.) appear on the aforementioned FIGS. 1a-1f, 2a, and 2b. [Note that the gas obtained from the absorption apparatus to the additional equipment to the stack in FIGS. 1d-1g, 2a, 2b comprises the nitrogen & other inert gases that are contained in the incoming pure oxygen feedstock together with other components in the absorption apparatus outlet gas and hence these nitrogen and other inert gases are removed at the stack. These gas amounts change depending on the oxygen content of the oxygen stream. With oxygen purity possibly being as low as 90% purity, this purge amount going to the additional equipment could contain up to 16.7 moles of nitrogen and other inert gas in principle. Any additional treatment of this purge to reduce sulfur dioxide emissions was not considered for this simulation in order to simplify the examples.]

From the above Examples, it is clearly apparent that the reactor temperature can be controlled independently and in a simple manner since only the amount in the first recycle circuit need be adjusted and hence there need be no impact on the rest of the process.

Further, more energy is recovered from the gas in the reactor gases heat exchanger since the gas volume entering the absorption apparatus or subsystem is reduced and less energy is transferred to the absorber acid as the gas is cooled from the gas inlet temperature to the absorber liquid temperature.

Further still, conversion of sulfur dioxide to sulfur trioxide in the sulfuric acid production system embodiment can be maximized in the contact apparatus without impacting reactor temperature thereby allowing complete freedom in the design and operation of the contact apparatus.

Note also that the mole ratios of gases in the second recycle circuit compared to the reactor outlet gases in the inventive embodiments of FIGS. 2a and 2b are about 0.14 and 0.16 respectively. However the mole ratios of gases in the recycle circuits compared to the reactor outlet gases in the prior art embodiments of FIGS. 1e and 1g are about 0.75 and 0.55 respectively (i.e. >>0.2 and thus significantly greater than in the inventive embodiments).

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A system for the production of sulfuric acid comprising:
a reactor for the combustion of sulfur to sulfur dioxide comprising an inlet for a supply of sulfur, an inlet for a supply of oxygen at ≥90% purity by volume, a recycle inlet for recycle gases, and an outlet for reactor outlet gases comprising sulfur dioxide;
a reactor gases heat exchanger for cooling reactor outlet gases comprising an inlet fluidly connected to the reactor outlet and an outlet for cooled reactor outlet gases;
a contact apparatus for the conversion of sulfur dioxide to sulfur trioxide comprising an inlet connected to the reactor gases heat exchanger outlet and an outlet for contact apparatus gases;
an absorption apparatus for absorbing sulfur trioxide into sulfuric acid to form more concentrated sulfuric acid comprising an inlet fluidly connected to the contact apparatus outlet, an outlet for the concentrated sulfuric acid, and an outlet for unabsorbed contact apparatus gases;
a first recycle circuit comprising a first pump and fluidly connecting the reactor gases heat exchanger outlet to the recycle inlet of the reactor; and
a second recycle circuit comprising a second pump and fluidly connecting the outlet of the absorption apparatus for unabsorbed contact apparatus gases to the recycle inlet of the reactor.

2. The system of claim 1 wherein the reactor consists of a single stage.

3. The system of claim 1 wherein the reactor is the only reactor for the combustion of sulfur to sulfur dioxide in the system.

4. The system of claim 3 is absent a submerged combustion reactor.

5. The system of claim 1 wherein the reactor gases heat exchanger is the only reactor gases heat exchanger for cooling reactor outlet gases in the system.

6. The system of claim 1 wherein the first and second pumps are selected from the group consisting of fans, blowers and ejectors.

7. The system of claim 1 wherein the first recycle circuit comprises a recycle heat exchanger located before the first pump in the first recycle circuit.

8. A system for the production of sulfur dioxide liquid comprising:
a reactor for the combustion of sulfur to sulfur dioxide comprising an inlet for a supply of sulfur, an inlet for a supply of oxygen at ≥90% purity by volume, a recycle inlet for recycle gases, and an outlet for reactor outlet gases comprising sulfur dioxide;
a reactor gases heat exchanger for cooling reactor outlet gases comprising an inlet fluidly connected to the reactor outlet and an outlet for cooled reactor outlet gases;
an absorption subsystem comprising an absorption apparatus for absorbing sulfur trioxide into sulfuric acid to form more concentrated sulfuric acid, wherein the absorption subsystem comprises an inlet fluidly connected to the reactor gases heat exchanger outlet, an outlet for unabsorbed reactor outlet gases, and an outlet for the concentrated sulfuric acid;
a liquefaction apparatus for the conversion of sulfur dioxide gas to sulfur dioxide liquid comprising an inlet connected to the absorption subsystem outlet, an outlet for liquefaction apparatus gases, and an outlet for liquid sulfur dioxide;
a first recycle circuit comprising a first pump and fluidly connecting the reactor gases heat exchanger outlet to the recycle inlet of the reactor; and
a second recycle circuit comprising a second pump and fluidly connecting the outlet of the liquefaction apparatus for liquefaction apparatus gases to the recycle inlet of the reactor.

9. The system of claim 8 wherein the absorption subsystem comprises an absorption heat exchanger located between the absorption subsystem inlet and the absorption apparatus.

10. A method for producing sulfuric acid comprising:
obtaining the system of claim 1;
supplying sulfur and oxygen at ≥90% purity to the sulfur inlet and the oxygen inlet of the reactor respectively;
reacting the sulfur and oxygen in the reactor thereby producing reactor outlet gases comprising sulfur dioxide;
directing the reactor outlet gases from the reactor outlet to the reactor gases heat exchanger inlet;
cooling the reactor outlet gases in the reactor gases heat exchanger thereby producing cooled reactor outlet gases;
directing a contact apparatus portion of the cooled reactor outlet gases to the contact apparatus inlet;
pumping a recycle portion of the cooled reactor outlet gases to the recycle inlet of the reactor using the first pump in the first recycle circuit;
converting sulfur dioxide in the contact apparatus portion of the cooled reactor outlet gases in the contact apparatus thereby producing contact apparatus gases comprising sulfur trioxide;
directing the contact apparatus gases from the contact apparatus outlet to the absorption apparatus inlet;
absorbing sulfur trioxide from the contact apparatus gases into sulfuric acid to form more concentrated sulfuric acid; and
pumping a recycle portion of the unabsorbed contact apparatus gases to the recycle inlet of the reactor using the second pump in the second recycle circuit.

11. The method of claim 10 wherein the ratio of moles of gases in the contact apparatus portion of the reactor outlet gases to the total moles of gases in the reactor outlet gases is less than 0.5

12. The method of claim 10 wherein the ratio of moles of gases in the recycled unabsorbed contact apparatus gases to the moles of gases in the reactor outlet gases is less than 0.2.

13. The method of claim 10 wherein the concentration of inert gases in the reactor outlet gases is less than 30 mole %.

14. The method of claim 10 wherein the concentration of sulfur dioxide in the reactor outlet gases is greater than 30 mole %.

15. The method of claim 10 wherein the ratio of moles of oxygen to moles of sulfur dioxide in the reactor outlet gases is less than 0.65.

16. The method of claim 10 wherein the temperature in the reactor is less than 1500° C.

17. The method of claim 10 wherein the first recycle circuit in the system comprises a recycle heat exchanger and the method comprises cooling the recycle portion of the cooled reactor outlet gases in the first recycle circuit in the recycle heat exchanger.

18. A method for producing sulfur dioxide liquid comprising:
obtaining the system of claim 8;
supplying sulfur and oxygen at ≥90% purity to the sulfur inlet and the oxygen inlet of the reactor respectively;
reacting the sulfur and oxygen in the reactor thereby producing reactor outlet gases comprising sulfur dioxide;
directing the reactor outlet gases from the reactor outlet to the reactor gases heat exchanger inlet;
cooling the reactor outlet gases in the reactor gases heat exchanger thereby producing cooled reactor outlet gases;
directing a liquefaction apparatus portion of the cooled reactor outlet gases to the absorption subsystem inlet;
pumping a recycle portion of the cooled reactor outlet gases to the recycle inlet of the reactor using the first pump in the first recycle circuit;
absorbing sulfur trioxide from the liquefaction apparatus portion of the cooled reactor outlet gases into sulfuric acid to form more concentrated sulfuric acid and unabsorbed reactor outlet gases comprising sulfur dioxide;
directing the unabsorbed reactor outlet gases to the liquefaction apparatus inlet;
liquefying sulfur dioxide in the unabsorbed reactor outlet gases to produce liquid sulfur dioxide and liquefaction apparatus gases; and
pumping a recycle portion of the liquefaction apparatus gases to the recycle inlet of the reactor using the second pump in the second recycle circuit.
